(19) United States
(12) Patent Application Publication
(10) Pub. No.: US 2013/0164990 A1
(43) Pub. Date: Jun. 27, 2013

(54) ELECTRICAL CONNECTOR

(71) Applicant: Chou Hsien TSAI, Taipei Hsien (TW)

(72) Inventor: Chou Hsien TSAI, Taipei Hsien (TW)

(21) Appl. No.: 13/723,038

(22) Filed: Dec. 20, 2012

(30) Foreign Application Priority Data
Dec. 21, 2011 (TW) 100224168

(51) Int. Cl. H01R 13/516

(52) U.S. Cl. CPC H01R 13/516
USPC 439/660

(57) ABSTRACT

An electrical connector includes first and second insulating seats and one row of first and second terminals. The first insulating seat, having front and rear sections respectively formed with a first surface and a support portion, is formed with one row of first terminal slots. The first surface faces a joint surface of a docking connector. The second insulating seat stacked above the support portion is formed with one row of second terminal slots within which the first terminals are assembled. The first terminal has a pin projecting from the first insulating seat, a fixing portion fixed to the first terminal slot, and a first connection portion arranged on the first surface. The second terminal assembled within the second terminal slot has a pin projecting from the second insulating seat, a fixing portion fixed to the second terminal slot, and a connection portion arranged behind the first connection portion.

### BACKGROUND OF THE INVENTION

1. Field of the Invention

The invention relates in general to an electrical connector, and more particularly to an electrical connector having two insulating seats and one row of terminals disposed on each of the insulating seats.

2. Related Art

Referring to FIGS. 1 to 3, a conventional USB 3.0 mobile disk has a socket shell 10, a plastic seat 15, a circuit board 20 and an external casing 25.

The socket shell 10 is made of a metal material and has open front and rear ends.

The upper rear section of the plastic seat 15 is a top surface 16. The upper front section of the plastic seat 15 is a joint surface 18 lower than the top surface 16. The lower front section of the plastic seat 15 is a bottom surface 17. One row of first terminals 30 and one row of second terminals 35 are disposed on the plastic seat 15. The first terminal 30 has an elastically unmovable first connection portion 31 in flat surface contact with the joint surface 18, and a pin 32 projecting from the rear end of the plastic seat 15. The second terminal 35 has a vertically elastically movable second connection portion 36 projecting from the joint surface 18, and a pin 37 projecting from the rear end of the plastic seat 15. The plastic seat 15 is disposed in the socket shell 10. The top surface 16 and the bottom surface 17 of the plastic seat 15 rest against and are positioned with the socket shell 10. A connection slot 12 is formed between the joint surface 18 and the socket shell 10.

An electronic unit 21 is electrically connected to and disposed on the circuit board 20. One row of bonding points 22 are disposed on the front section of the circuit board 20. The electronic unit 21 is a storage unit. The pins 32 of the one row of first terminals 30 and the pins 37 of the one row of second terminals 35 are bonded to the one row of bonding points 22.

The external casing 25 is fixed to the socket shell 10 and covers the rear section of the socket shell 10 and the circuit board 20.

The conventional structure has the following drawbacks. The plastic seat 15 needs to have the one row of first terminals 30 and one row of second terminals 35, which cannot be easily manufactured.

### SUMMARY OF THE INVENTION

A main object of the invention is to provide an electrical connector including stacked first and second insulating seats, each of which has one row of terminal slots, within which one row of terminals are assembled so that the manufacturing processes can be simplified.

A secondary object of the invention is to provide an electrical connector including stacked first and second insulating seats, each of which has one row of terminals, wherein each of the first and second insulating seats has a joint surface, on which connection portions of the terminals are separately arranged so that the manufacturing processes can be simplified.

To achieve the above-identified objects, the invention provides an electrical connector including a first insulating seat, a second insulating seat, one row of first terminals and one row of second terminals. The first insulating seat has a front section formed with a first surface, and a rear section formed with a support portion. The support portion is more depressed than the first surface, the first insulating seat is formed with one row of terminal slots, which extend from the support portion to the first surface and are exposed, and the first surface faces a joint surface of a docking electrical connector. The second insulating seat is stacked above the support portion of the first insulating seat and is formed with one row of terminal slots. The one row of first terminals are assembled within the one row of terminal slots of the first insulating seat. The first terminal has a first pin, a first fixing portion, an extension and a first connection portion, the first fixing portion is fixed to the terminal slot of the first insulating seat, the one row of first connection portions are arranged on the first surface, and the one row of first pins project from the first insulating seat. The one row of second terminals are assembled within the one row of terminal slots of the second insulating seat. The second terminal has a second pin, a second fixing portion, an extension and a second connection portion, the second fixing portion is fixed to the terminal slot of the second insulating seat, the one row of second connection portions are arranged behind the one row of first connection portions, and the one row of second pins project from the second insulating seat.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a pictorially exploded view showing a conventional USB 3.0 mobile disk with a socket shell.

FIG. 2 is a pictorially semi-assembled view showing the conventional USB 3.0mobile disk with the socket shell.

FIG. 3 is a pictorially assembled view showing the conventional USB 3.0 mobile disk with the socket shell.

FIG. 4 is a pictorially exploded view showing a first embodiment of the invention.

FIG. 5 is a pictorially assembled view showing the first embodiment of the invention.

FIG. 6 is a cross-sectional side view showing the first embodiment of the invention.

FIG. 6A is a top view showing the arrangement of two rows of terminals according to the first embodiment of the invention.

FIG. 7 is a pictorially assembled view showing the first embodiment of the invention.

FIG. 8 is a pictorially assembled view showing the first embodiment of the invention.

FIG. 9 is a pictorially exploded view showing a second embodiment of the invention.

FIG. 9A is a side view showing the arrangement of two rows of terminals of the second embodiment of the invention.

FIG. 10 is a pictorially exploded view showing the third embodiment of the invention.

FIG. 11 is a cross-sectional side view showing the third embodiment of the invention.

FIG. 12 is a pictorially exploded view showing the fourth embodiment of the invention.

FIG. 13 is a pictorially exploded view showing the fifth embodiment of the invention.

FIG. 14 is a cross-sectional side view showing the fifth embodiment of the invention.

FIG. 15 is a cross-sectional side view showing the sixth embodiment of the invention.

FIG. 16 is a pictorially exploded view showing the seventh embodiment of the invention.

FIG. 17 is a cross-sectional side view showing the seventh embodiment of the invention.

FIG. 18 is a pictorially exploded view showing the eighth embodiment of the invention.

FIG. 19 is a cross-sectional side view showing the eighth embodiment of the invention.

FIG. 20 is a partially pictorially assembled view showing the eighth embodiment of the invention.

FIG. 21 is a pictorially assembled view showing the front metal casing of the eighth embodiment of the invention.

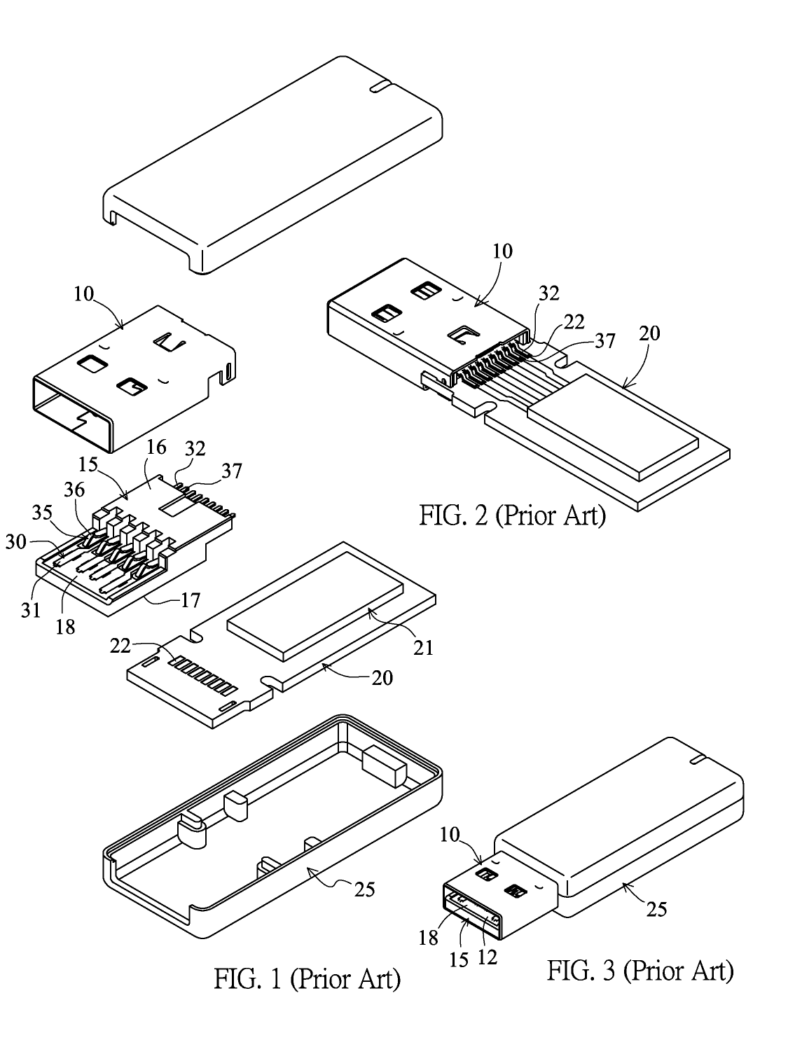

### DETAILED DESCRIPTION OF THE INVENTION

The present invention will be apparent from the following detailed description, which proceeds with reference to the accompanying drawings, wherein the same references relate to the same elements.

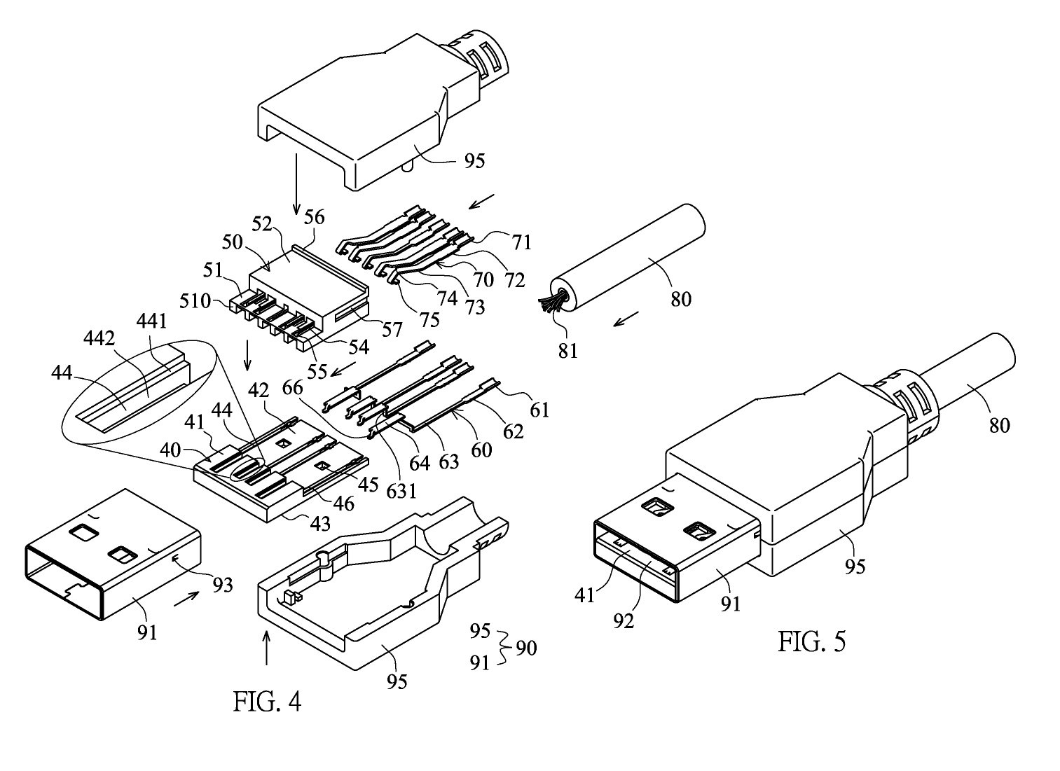

Referring to FIGS. 4 to 6, the first embodiment of the invention is a USB 3.0 cable plug including a first insulating seat 40, a second insulating seat 50, one row of first terminals 60, one row of second terminals 70, an electrical connection cable 80 and a housing 90.

The first insulating seat 40 is made of a plastic material. The upper front section of the first insulating seat 40 has a first surface 41. The lower rear section of the first insulating seat 40 has a support portion 42. The support portion 42 is more depressed than the first surface 41. A vertical surface 46 perpendicular to the first surface is formed between the first surface 41 and the support portion 42. The vertical surface 46 has left and right edges flush with each other. The bottom of the first insulating seat 40 is a resting portion 43. The top of the first insulating seat 40 is formed with one row of terminal slots 44 extending in the front-to-rear direction, and two engagement holes 45. The terminal slot 44 extends from the support portion 42 to the first surface 41 through the vertical surface 46, and the overall section of the terminal slot 44 is substantially exposed. The front end of the terminal slot 44 has an engaging slot 410. The middle 442 of the terminal slot 44 on the first surface is more depressed than two sides 441 of the terminal slot 44 and communicates with the engaging slot 410.

The second insulating seat 50 is made of a plastic material. The front section of the second insulating seat 50 is formed with a second surface 51. The rear section of the second insulating seat 50 is formed with a resting portion 52, which is higher than the second surface 51. The second insulating seat 50 is formed with one row of terminal slots 54 extending in the front-to-rear direction. The terminal slot 54 extends from the rear end of the second insulating seat to the second surface 51 and is exposed from the second surface 51 and formed with a through slot, which is opened in the vertical direction. Two sides of the front section of the terminal slot 54 are formed with engaging surfaces 55, and the upper edge of the front end of the terminal slot 54 is closed. The rear end of the resting portion 52 is formed with an upward flange 56. Each of two sides of the second insulating seat 50 is formed with an engaging slot 57. The front end of the second insulating seat is formed with a vertical surface 510 perpendicular to the second surface 51. The vertical surface 510 has left and right edges flush with each other. The second insulating seat 50 is stacked above the support portion 42 of the first insulating seat 40. The first and second joint surfaces 41 and 51 rest against and are flush with each other. The first and second joint surfaces 41 and 51 may face a joint surface of a docking female electrical connector. The second insulating seat 50 has two tenons (not shown) engaging with the two engagement holes 45. The first and second surfaces 41 and 51 are flush with each other, rest against each other, or are flush with each other and rest against each other. The first and second insulating seats 40 and 50 engage with each other.

The one row of first terminals 60 are assembled within the terminal slots 44 of the first insulating seat 40. The first terminal sequentially has a first pin 61, a first fixing portion 62, an extension 63 and a first connection portion 64 from back to front. The fixing portion 62 is fixed to the terminal slot 44. The one row of first connection portions 64 are arranged on the first surface 41. The first pin 61 projects from the rear end of the first insulating seat 40. The one row of first connection portions 64 are plane interfaces. The one row of first connection portions 64 are in flat surface contact with the terminal slot 44 and are elastically unmovable. The extension 63 has a vertical section 631 matching with the vertical surface 46 of the first insulating seat. The front end of the first connection portion 64 is formed with an engaging portion 66, which is narrower and lower than the first connection portion 64. The first connection portion 64 is in flat surface contact with two sides of the terminal slot 44 of the first surface. The engaging portion 66 engages with the engaging slot 410 through the middle of the terminal slot 44 of the first surface.

The one row of second terminals 70 are assembled within the terminal slots 54 of the second insulating seat 50 from back to front. The second terminal sequentially has a second pin 71, a second fixing portion 72 and an elastic arm 73 from back to front. The front section of the elastic arm 73 is curved to form a projecting second connection portion 74, and the front end of the elastic arm 73 is bent back to form a laterally projecting position restricting projection 75, which is wider than the second connection portion 74. The second connection portion 74 is more convex than the first connection portion 64. The fixing portion 72 is fixed to the terminal slot 54. The one row of second connection portions 74 project from the one row of terminal slots 54 and the second surface 51 and are vertically elastically movable. The position restricting projection 75 is restricted under the engaging surface 55. The second pin 71 projects from the rear end of the second insulating seat 50. The one row of second pins 71 are higher than the one row of first pins 61. The one row of first connection portions 64 are located behind the one row of second connection portions 74.

The left and right positions of the front sections of the elastic arms 73 of the one row of second terminals 70 can be restricted by the spacers between the one row of terminal slots 54 of the second surface 51, and the upward positions thereof can be restricted by the engaging surface 55. That is, the elastic arm 73 of the second terminal 70 is restricted within the second insulating seat 50 and cannot be pulled out upwards.

Under the consideration of the limited length of the second surface 51, the front section of the second connection portion 74 of this embodiment is bent back to form a wider position restricting projection 75, so that backward movement of the position restricting projection 75 can be easily restricted.

The electrical connection cable 80 includes nine electrical wires 81.

The housing 90 includes a front metal casing 91 and a plastic casing 95, wherein the front metal casing 91 surrounds and fixes the first and second insulating seats 40 and 50. The resting portions 43 and 52 of the first and second insulating seats 40 and 50 rest against and are positioned with the front metal casing 91. The first and second insulating seats 40 and 50 are disposed in the front metal casing 91. The first and second joint surfaces 41 and 51 and the front metal casing 91 form a fitting slot 92. Each of two sides of the front metal casing 91 is formed with an elastic snap 93. The plastic casing 95 has upper and lower seats closed upon each other and covers and fixes the rear section of the front metal casing 91.

In assembly, as shown in FIG. 7, four of the nine electrical wires 81 of the electrical connection cable 80 are grouped into one set and connected to the first pins 61 of the one row of first terminals 60, and then each first pin 61 covers and connects one electrical wire 81. The remaining five of the nine electrical wires 81 are grouped into another set and connected to the second pins 71 of the one row of second terminals 70, and then each second pin 71 covers and connects one electrical wire 81. Next, as shown in FIG. 8, the second insulating seat 50 is stacked above the support portion 42 of the first insulating seat 40. The first and second joint surfaces 41 and 51 rest against and are flush with each other. The second insulating seat 50 has two tenons (not shown) engaging with the two engagement holes 45. Then, the stacked first and second insulating seats 40 and 50 are pushed into the front metal casing 91 from back to front. At this time, the flange 56 of the rear end of the second insulating seat 50 rests against the rear end of the front metal casing 91, and the elastic snaps 93 of the front metal casing 91 engage with the engaging slots 57 on two sides of the second insulating seat 50. Finally, the plastic casing 95 covers and fixes the rear section of the front metal casing 91.

According to the above-mentioned structure, each of the stacked first and second insulating seats 40 and 50 has one row of terminals, and each of the first and second insulating seats 40 and 50 has a joint surface, on which the connection portions of the terminals are arranged. In addition, the stacked first and second insulating seats 40 and 50 can be easily fixed to the housing, thereby simplifying the manufacturing processes. In addition, the pins of the two rows of terminals are arranged in upper and lower rows and are separated, thereby avoiding the electrical interference.

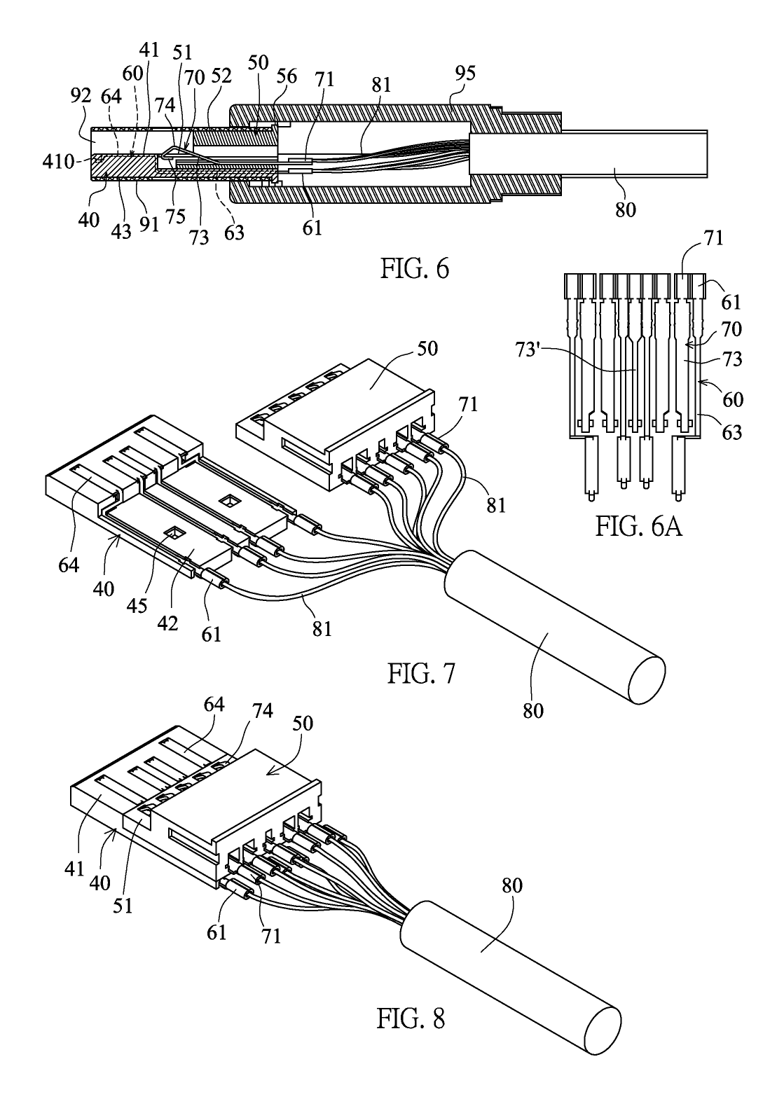

As shown in FIG. 6A, the one row of first connection portions 64 and the one row of second connection portions 74 satisfy the USB 3.0 specification. The one row of first terminals 60 and the one row of second terminals 70 have the arrangement structures for the high-frequency signal transmission. The one row of first terminals 60 contain four terminals, wherein the middle two terminals are a pair of signal terminals, and the terminals on two sides are a power terminal and a ground terminal. The one row of second terminals 70 contain five terminals, wherein the middle terminal is a ground terminal, and the terminals on each of two sides of the ground terminal are a pair of signal terminals. The extensions 63 of the power and ground terminals of the one row of first terminals 60 are respectively turned outwards and staggered so that the first pins 61 are disposed on the outer side of the second pins 71 of the two pairs of signal terminals of the one row of second terminals 70, and the first pins 61 of the one pair of signal terminals of the one row of first terminals 60 are respectively disposed on the inner side of the second pins 71 of the two pairs of signal terminals of the one row of second terminals 70 or are respectively on the outer side of the second pin 71 of the ground terminal of the one row of second terminals 70. Thus, the extensions of the one row of first terminals and the elastic arms of the one row of second terminals are completely staggered without overlap in the top-viewing direction, and the elastic arms of the one row of second terminals cannot touch the one row of first terminals when the elastic arms of the one row of second terminals elastically move up and down. In addition, a width of the elastic arm 73′ of the ground terminal of the one row of second terminals is smaller than a width of the elastic arm 73 of at least one of the signal terminals.

In addition, the extensions 63 of the one row of first terminals and the elastic arms 73 of the one row of second terminals are staggered with a vertical step in the side-viewing direction, so that the elastic arms 73 of the one row of second terminals cannot touch the one row of first terminals when the elastic arms 73 of the one row of second terminals elastically move up and down.

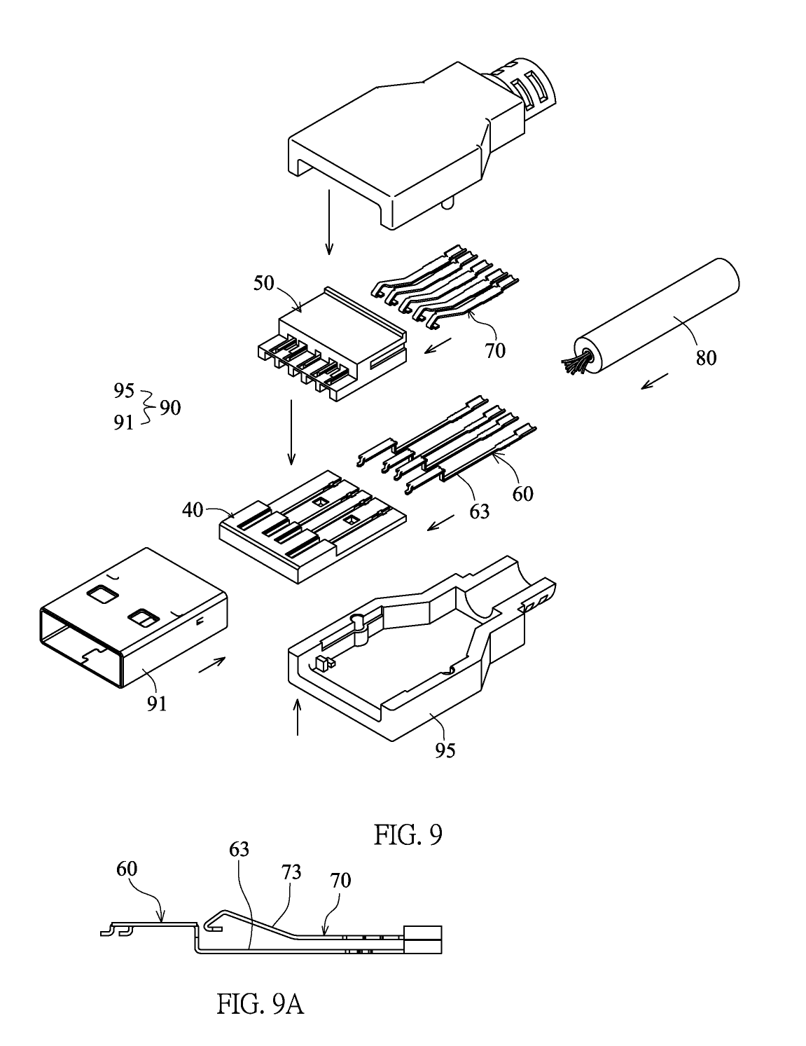

As shown in FIGS. 9 and 9A, the second embodiment of the invention is substantially the same as the first embodiment except for the difference that the extensions 63 of the power and ground terminals on two sides of the one row of first terminals 60 of this embodiment extend in a straight line and are respectively staggered outwards. Although the extensions 63 of the two first terminals 60 overlap with the elastic arms 73 of the two second terminals in the top-viewing direction, the elastic arms 73 of the one row of second terminals cannot touch the one row of first terminals when the elastic arms 73 of the one row of second terminals elastically move up and down because the extensions 63 of the one row of first terminals and the elastic arms 73 of the one row of second terminals are staggered with a vertical step in the side-viewing direction.

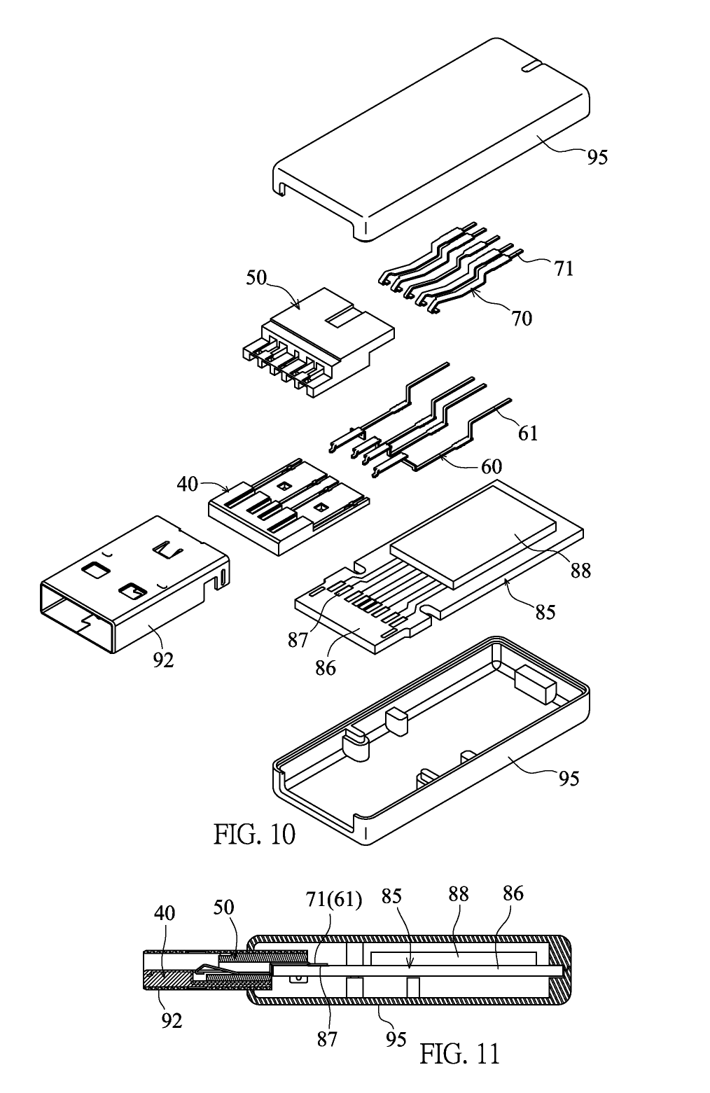

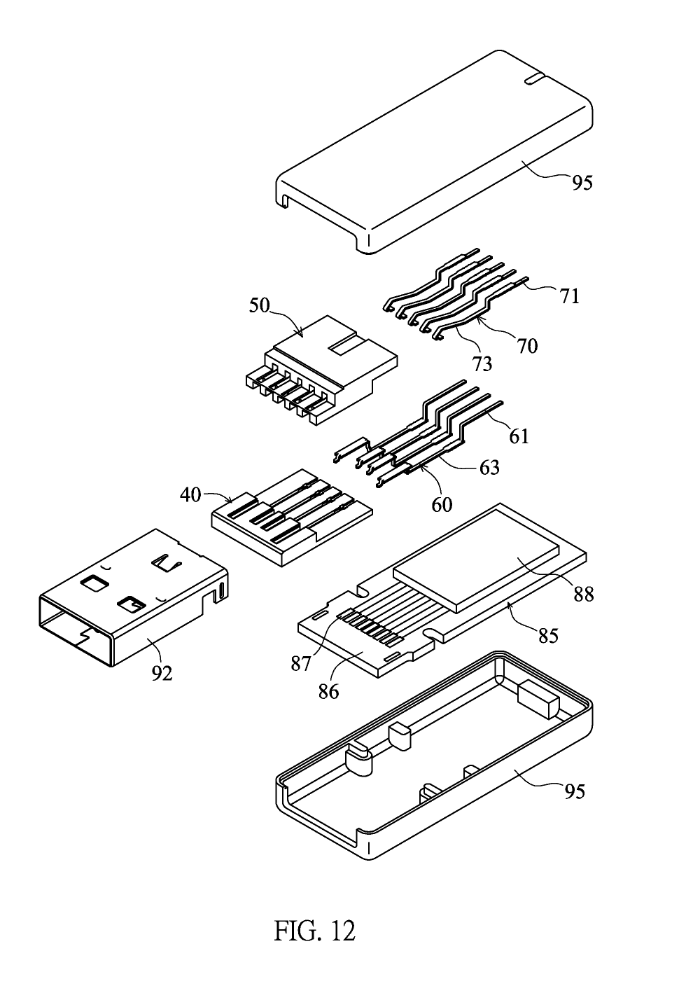

As shown in FIGS. 10 and 11, the third embodiment of the invention is a USB 3.0mobile disk including a first insulating seat 40, a second insulating seat 50, one row of first terminals 60, one row of second terminals 70, an electronic module 85 and a housing 90.

This embodiment is substantially the same as the first embodiment except for the difference that the electronic module 85 of this embodiment has a printed circuit board 86, on which one row of nine connection portions 87 and an electronic unit 88 are disposed. The one row of connection portions 87 are electrically connected to the electronic unit 88. The electronic unit 88 is a storage unit including a memory and associated electronic elements. The rear sections of the first pins 61 of the one row of first terminals 60 and the rear sections of the second pins 71 of the one row of second terminals 70 are in the form of horizontal pins and disposed on the same level. The first pins 61 of the one row of first terminals 60 and the second pins 71 of the one row of second terminals 70 are bonded and electrically connected to the one row of nine connection portions 87 of the electronic module 85 by way of surface mount technology (SMT).

As shown in FIG. 12, the fourth embodiment of the invention is substantially the same as the third embodiment except for the difference that the extensions 63 of the power and ground terminals on two sides of the one row of first terminals 60 in this embodiment extend in straight lines without being turned outwards and staggered.

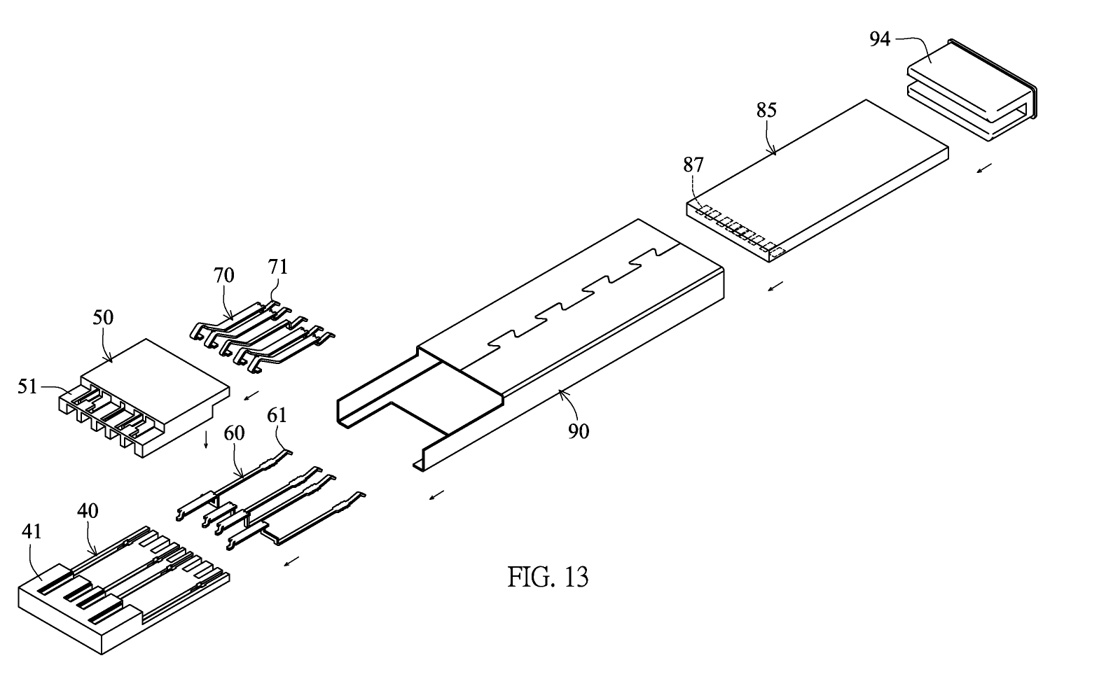

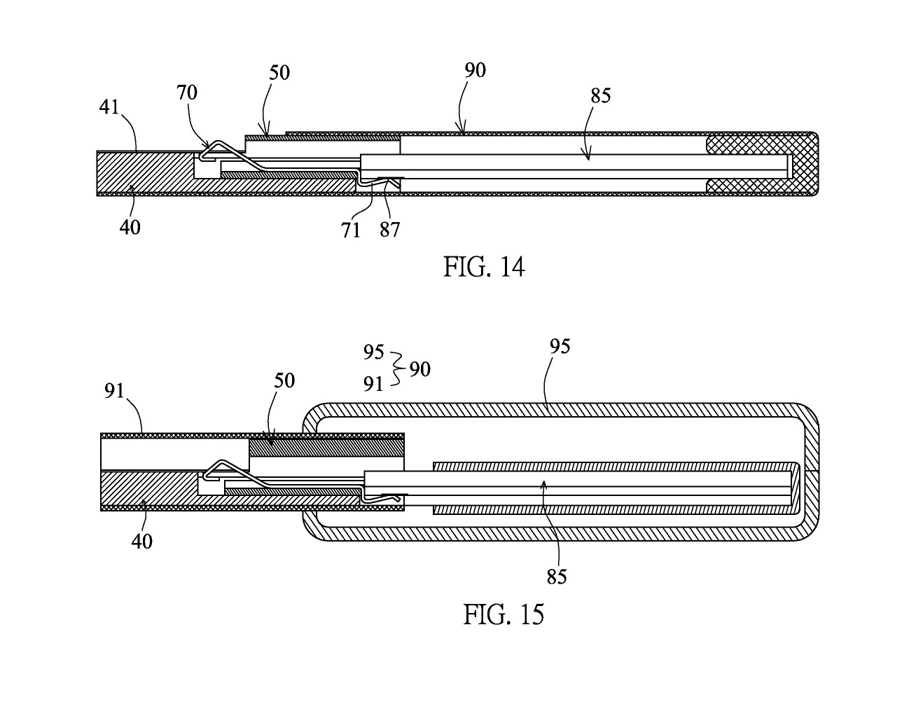

As shown in FIGS. 13 and 14, the fifth embodiment of the invention is substantially the same as the third embodiment except for the difference that each of the first pins 61 of the one row of first terminals 60 and each of the second pins 71 of the one row of second terminals 70 in this embodiment are formed with a projection and in the form of an elastic pin.

The electronic module 85 has a printed circuit board having one surface formed with one row of connection portions 87, and the other surface electrically connected to an electronic unit and being packaged. The electronic module 85 is a storage module. The first pins 61 of the one row of first terminals 60 and the second pins 71 of the one row of second terminals 70 can directly elastically contact the connection portions 87 and then may be bonded. The housing 90 is a metal casing extending to the front end of the first insulating seat 40 and covering two side surfaces and a bottom surface of the first insulating seat 40. In addition, a rear cover 94 is provided to cover the rear end.

In this embodiment, the sheet-like male plug without the fitting slot is provided. If the two sides of the housing 90 project from the first surface 41, the mistake-proof structure can be formed.

In addition, the electronic module may also be a memory card.

Furthermore, the housing 90 may also be configured to entirely cover the first and second insulating seats 40 and 50, so that the male plug with the fitting slot is formed.

As shown in FIG. 15, the sixth embodiment of the invention is substantially the same as the fifth embodiment except for the difference that the housing 90 of this embodiment includes a front metal casing 91 and a plastic casing 95.

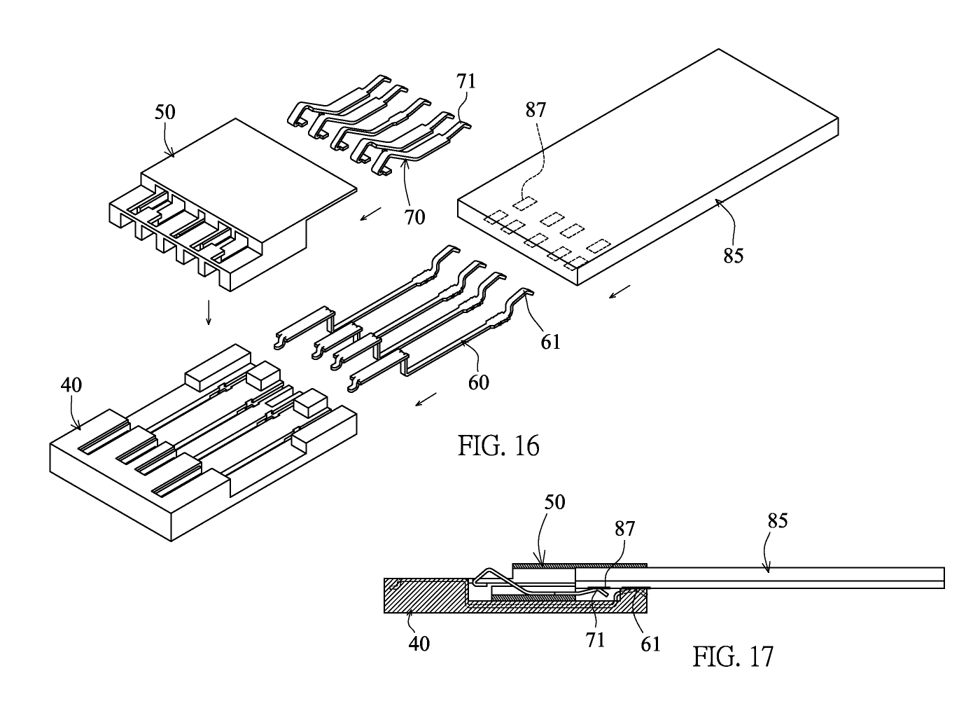

As shown in FIGS. 16 and 17, the seventh embodiment of the invention is substantially the same as the fifth embodiment except for the difference that the first pins 61 of the one row of first terminals 60 and the second pins 71 of the one row of second terminals 70 in this embodiment are arranged at front positions and rear positions, respectively.

The feature of the structure of this embodiment may also be applied to other electronic devices. By only modifying the electronic module, an integrated circuit (IC) controller, a wireless transceiver, a MP3 device, a GPS device, a voice recorder, a television receiving module, a wireless network card module, a digital camera and any other electronic device may be provided.

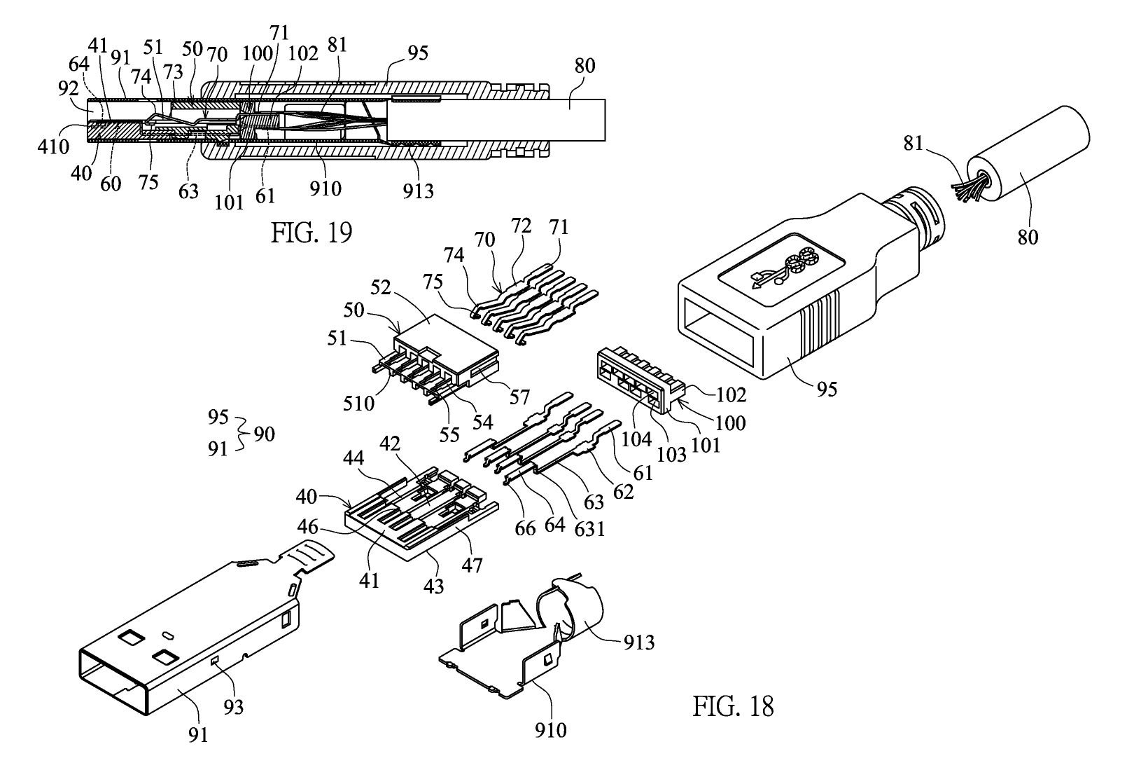

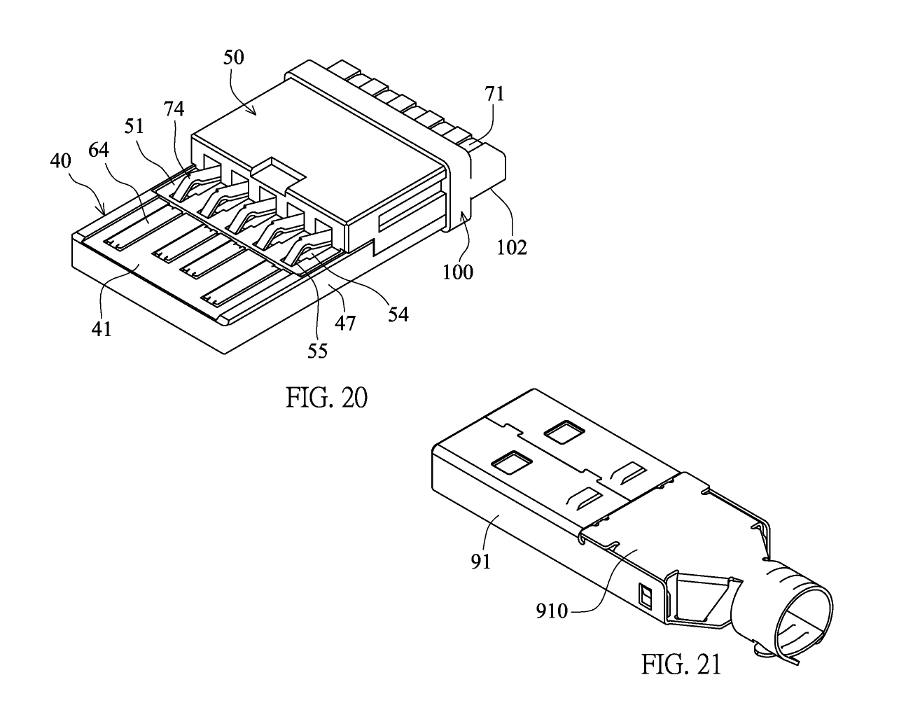

As shown in FIGS. 18 to 21, the 14^{th} embodiment of the invention is a USB 3.0 cable plug, which is substantially the same as that of each of the first and second embodiments except for the difference that this embodiment additionally has a rear plug 100. The rear plug 100 is disposed at the rear ends of the first and second insulating seats 40 and 50. The rear plug 100 tightly plugs into the front metal casing 91. The rear plug 100 has a wider front section 101 and a narrower rear section 102, has a T shape when viewed from one side, and has two rows of through holes 103 and 104 through which the one row of first pins 61 and the one row of second pins 71 pass. The one row of first pins 61 and the one row of second pins 71 are arranged at different levels and in flat surface contact with top and bottom surfaces of the rear section 102, respectively. In addition, the support portion 42 of the first insulating seat 40 has two lateral sides 47 and is in the form of a support slot having a front side and two lateral sides. The front metal casing 91 of the housing 90 is assembled with a rear casing 910. The rear end of the rear casing 910 is formed with a clip coil 913 for fixing the electrical connection cable 80.

This embodiment has the rear plug 100 tightly plugging into the front metal casing 91. Thus, when the integral plastic casing 95 is formed upon glue pouring, the glue cannot flow through the holes of the rear ends of the first and second insulating seats 40 and 50. In addition, the front metal casing 91 is assembled with the rear casing 910 to completely cover and shield the electrical wires of the electrical connection cable 80.

To sum up, the invention has the following advantages.

1. Each of the stacked first and second insulating seats is formed with one row of terminal slots and is assembled with one row of terminals. Each of the first and second insulating seats 40 and 50 has a joint surface arranged to separate the connection portions of the terminals thereon, so that the manufacturing processes can be simplified.

2. The pins of the two rows of terminals may be arranged in an upper row and a lower row separated from each other and may be electrically connected to the electrical connection cable. So, no electrical interference is induced.

3. The pins of the two rows of terminals can be arranged at the same level and thus can be easily electrically connected to an electronic module.

4. The one row of first connection portions 64 and the one row of second connection portions 74 satisfy the USB 3.0 specification. The one row of first terminals 60 and the one row of second terminals 70 have the arrangement structures for high-frequency signal transmission.

5. The extensions of the one row of first terminals and the elastic arms of the one row of second terminals are completely staggered without overlap in the top-viewing direction. The elastic arms of the one row of second terminals cannot touch the one row of first terminals when the elastic arms of the one row of second terminals elastically move.

7. The metal housing can completely cover and shield the electrical wires of the electrical connection cable.

8. The rear plug 100 is provided to tightly plug into the front metal casing 91.

Thus, when the integral plastic casing 95 is formed by way of glue pouring, the glue cannot flow through the holes of the rear ends of the first and second insulating seats 40 and 50.

9. The positions of the elastic arms of the one row of second terminals 70 can be directly restricted in the second insulating seat 50.

Although the electrical male plugs are described in the above-mentioned embodiments, the feature of the structure of the invention can also be applied to the female electrical connector, such as the USB 3.0 female electrical connector.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An electrical connector, comprising:
a first insulating seat having a front section formed with a first surface, and a rear section formed with a support portion, wherein the support portion is more depressed than the first surface, the first insulating seat is formed with one row of terminal slots, which extend from the support portion to the first surface and are exposed, and the first surface faces a joint surface of a docking electrical connector;
a second insulating seat, which is stacked above the support portion of the first insulating seat and is formed with one row of terminal slots;
one row of first terminals assembled within the one row of terminal slots of the first insulating seat, wherein the first terminal has a first pin, a first fixing portion, an extension and a first connection portion, the first fixing portion is fixed to the terminal slot of the first insulating seat, the one row of first connection portions are arranged on the first surface, and the one row of first pins project from the first insulating seat; and
one row of second terminals assembled within the one row of terminal slots of the second insulating seat, wherein the second terminal has a second pin, a second fixing portion, an extension and a second connection portion, the second fixing portion is fixed to the terminal slot of the second insulating seat, the one row of second connection portions are arranged behind the one row of first connection portions, and the one row of second pins project from the second insulating seat.

2. The electrical connector according to claim 1, further comprising a housing, which surrounds and fixes the first and second insulating seats, wherein each of the first and second insulating seats has a resting portion, which rests against and is positioned with the housing.

3. The electrical connector according to claim 1, wherein the first connection portions of the one row of first terminals are plane interfaces, the one row of first connection portions are elastically unmovable, each of the extensions of the one row of second terminals is an elastic arm, the elastic arm can elastically move up and down in the terminal slot of the second insulating seat and is curved to form the projecting second connection portion, and the second connection portion is more convex than the first connection portion.

4. The electrical connector according to claim 3, wherein a front section of the second insulating seat has a second surface, the second surface is disposed behind the first surface, the terminal slot of the second insulating seat extends to the second surface and is exposed from the second surface, the second connection portions of the one row of second terminals project from the one row of terminal slots and the second surface and are elastically movable above the one row of terminal slots.

5. The electrical connector according to claim 1, wherein a front section of the second insulating seat has a second surface, the second surface is disposed behind the first surface, the terminal slot of the second insulating seat extends to the second surface and is exposed from the second surface, and the one row of second connection portions are arranged on the second surface.

6. The electrical connector according to claim 3, wherein the one row of first connection portions and the one row of second connection portions satisfy a USB 3.0 specification.

7. The electrical connector according to claim 1, wherein the support portion of the first insulating seat has two lateral sides and is a support slot with a front side and the two lateral sides.

8. The electrical connector according to claim 1, wherein the one row of first pins and the one row of second pins are connected to electrical wires of an electrical connection cable, respectively, and each of the first and second pins is connected to one of the electrical wires.

9. The electrical connector according to claim 4, wherein an elastic arm of the second terminal is restricted within the second insulating seat and cannot be pulled out upwards.

10. The electrical connector according to claim 9, wherein a front end of the elastic arm of the second terminal is bent back and formed with a laterally projecting position restricting projection, two sides of the terminal slot of the second surface are formed with engaging surfaces, and the position restricting projection is restricted by the engaging surfaces.

11. The electrical connector according to claim 1 being an electrical male plug, wherein rear sections of the one row of first pins and rear sections of the one row of second pins are disposed on the same level and are electrically connected to an electronic module, and each of the rear sections of the one row of first pins and the rear sections of the one row of second pins has a projection and is in the form of an elastic pin or a horizontal pin.

12. The electrical connector according to claim 5, wherein each of the first and second insulating seats is made of a plastic material, and the first and second surfaces are flush with each other, rest against each other, or are flush with each other and rest against each other.

13. The electrical connector according to claim 1, wherein the first and second insulating seats engage with each other.

14. The electrical connector according to claim 6 being an electrical male plug, wherein the one row of first terminals contain four terminals, two middle terminals of the four first terminals are a pair of signal terminals, two terminals on two sides of the middle terminals are a power terminal and a ground terminal, the one row of second terminals contain five terminals, a middle terminal of the second terminals is a ground terminal, and two terminals on each of two sides of the ground terminal are a pair of signal terminals; wherein the one row of first terminals and the one row of second terminals have arrangement structures for high-frequency signal transmission, the first pins of the power and ground terminals of the one row of first terminals are respectively disposed on an outer side of the second pins of the two pairs of signal terminals of the one row of second terminals, and the first pins of the one pair of signal terminals of the one row of first terminals are respectively disposed on an inner side of the second pins of the two pairs of signal terminals of the one row of second terminals or are respectively disposed on the outer side of the second pins of the ground terminals of the one row of second terminals.

15. The electrical connector according to claim 1, wherein a vertical surface perpendicular to the first surface is formed between the first surface and the support portion of the first insulating seat, and the extension of the first terminal has a vertical section matching with a vertical surface of the first insulating seat.

16. The electrical connector according to claim 6 being an electrical male plug, wherein the one row of first terminals contain four terminals, wherein two middle terminals of the four terminals are a pair of signal terminals, two terminals of the four terminals on two sides of the middle terminals are a power terminal and a ground terminal, the one row of second terminals contain five terminals, extensions of the power and ground terminals on two sides of the one row of first terminals are respectively turned outwards and staggered, so that the extensions of the one row of first terminals and elastic arms of the one row of second terminals are completely staggered without overlap in a top-viewing direction, and the elastic arms of the one row of second terminals cannot touch the one row of first terminals when the elastic arms of the one row of second terminals elastically move up and down; or a width of the elastic arm of the ground terminal of the one row of second terminals is smaller than a width of the elastic arm of at least one of the signal terminals.

17. The electrical connector according to claim 6 being an electrical male plug, wherein the one row of first terminals contain four terminals, wherein two middle terminals of the four terminals are a pair of signal terminals, two terminals of the four terminals on two sides of the middle terminals are a power terminal and a ground terminal, the one row of second terminals contain five terminals, extensions of the one row of first terminals extend in straight lines, the extensions of the one row of first terminals and elastic arms of the one row of second terminals are staggered with a vertical step in a side-viewing direction, and the elastic arms of the one row of second terminals cannot touch the one row of first terminals when the elastic arms of the one row of second terminals elastically move up and down.

18. The electrical connector according to claim 2, wherein the housing comprises a front metal casing and a plastic casing, the front metal casing covers the first and second insulating seats, the first surface and the front metal casing form a fitting slot, the plastic casing integrally covers and fixes a rear section of the front metal casing, and the electrical connector further comprises a rear plug disposed on rear ends of the first and second insulating seats, wherein the rear plug tightly plugs into the front metal casing, and the rear plug has a through hole through which the one row of first pins and the one row of second pins pass.

19. The electrical connector according to claim 3, wherein a front end of the terminal slot of the first insulating seat has an engaging slot, a front end of the first connection portion has an engaging portion, and the engaging portion engages with the engaging slot.

20. The electrical connector according to claim 19, wherein a middle of the terminal slot of the first surface is more depressed than two sides of the terminal slot of the first surface and is communicated with the engaging slot, the engaging portion is narrower and lower than the first connection portion, the first connection portion is in flat surface contact with the two sides of the terminal slot of the first surface, and the engaging portion engages with the engaging slot through the middle of the terminal slot of the first surface.
